(19) United States
(12) Patent Application Publication
(10) Pub. No.: US 2025/0077563 A1
(43) Pub. Date: Mar. 6, 2025

(54) Construction Activity Summary Generator with Integrated Solutions Engine

(71) Applicant: Procore Technologies, Inc., Carpinteria, CA (US)

(72) Inventors: Matt Man, Thornhill (CA); Elijah El-Haddad, Poway, CA (US); Gagik Hacobian, La Crescenta, CA (US); Julian Clayton, Milford, CT (US); David Borden, Austin, TX (US); Mohammad Mostafa Soltani, North York (CA); Parker Quackenbush, River Falls, WI (US)

(21) Appl. No.: 18/457,599

(22) Filed: Aug. 29, 2023

(51) Int. Cl. G06F 16/34; G06F 16/33; G06F 16/332; G06Q 50/08

(52) U.S. Cl. CPC G06F 16/345; G06F 16/3329; G06F 16/3344; G06Q 50/08

(57) ABSTRACT

A computing platform is configured to: (i) train a large language model (LLM) by carrying out a first machine learning process on a first training data set that includes first construction-based data associated with one or more of a user, a plurality of reference construction projects, a construction-based application of the computing platform, or combinations thereof, (ii) receive a request to generate a construction activity summary, which includes a context-based prompt, (iii) generate the construction activity summary by inputting the request into the LLM, the construction activity summary including a contextual response, and (iv) retrain the LLM by carrying out a second machine learning process on a second training data set that includes the first training data set and one or more of the context-based prompt, the construction project data, an evaluation, the contextual response, the construction activity summary, a given timeframe, the request, input, or combinations thereof.

### BACKGROUND

Construction projects are often complex endeavors involving the coordination of many professionals across several discrete phases. Such projects have multiple planning and building phases that occur and require lengthy communication. The planning phases may involve contract bidding, contractor selection, project feasibility studies, regulatory approval and/or permitting, among other known planning phases.

Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well.

After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction or implementation phase, construction professionals begin to construct the project based on the finalized plans.

Such construction planning, design, and implementation may involve massive amounts of events and information that requires documentation and accurate reporting. Software technology has been developed to enable electronic management of information associated with a construction project, which includes documenting events and information associated with a construction project.

### Overview

As mentioned above, software technology has been developed to enable computing platforms to ingest and store information associated with construction projects, to facilitate electronic management of construction project information. However, the construction industry remains susceptible to various inefficiencies related to information management and compilation of said information. Particularly, many issues arise regarding proper organization of these materials for the purposes of construction activity summary documentation.

As defined herein, a “construction project” refers to any building, construction, demolition, and/or removal of a structure, tenant and/or owner improvement of an existing space, public or private infrastructure, landscaping, greenery, or otherwise large scale movement or construction of property on real estate. A “construction project task” refers to one or more sub-divided tasks associated with the defined construction project, which may be one of a planning task, an engineering task, and/or a construction task, among other possibilities. While data is collected from a variety of different operations and/or tasks associated with a construction project, as discussed in more detail below, there is a need to organize the collected data and outcomes of any processing of said data, on a regular, timely basis.

Construction projects and, more generally, the construction industry require many reporting tasks that involve documentation, which includes, but is not limited to including, documenting who did what construction tasks, when said construction tasks were performed, where a construction task occurred, why conditions associated with a construction task occurred, how well a construction task was performed, among other things. Further, it is valuable to many parties to a construction project or task (e.g., subcontractors, general contractors, owners, financiers, among other parties) that they know, on a timely basis, the status of said information or reporting tasks. The generation and handoff of this type of information is often a massive burden on the construction team, during the construction project and/or after the project is complete.

To that end, management personnel of a construction project (e.g., foremen, superintendents, etc.) must balance their time between performing and/or managing the actual construction work, in the field, versus using their time to document and organize the aforementioned reporting and/or gathering of information. As a result, work summaries, based on the described reporting or information, may be neglected, may be done in an incomplete manner, and/or may be unsatisfactory to upstream parties to the construction project. With unorganized or haphazardly organized reporting information, the daily, weekly, and/or monthly status summaries may lack completeness, may have omissions, may be insufficiently supported due to a lack of backup materials, and/or may otherwise be sub-optimal for use by upstream parties. Incorrect and/or incomplete summaries may have unwanted consequences, such as, but not limited to, legal risks, contract risks, commercial risks and/or claims, scheduling issues, among other things.

These summaries or, rather, “construction activity summaries,” as defined herein, may be any summary of information associated with a construction project that is constrained by a specific timeframe. Said timeframe may refer to any period of time (e.g., one or more days, one or more weeks, one or more months, etc.) over which the construction project and/or tasks thereof are performed. As described above, during the course of a construction project, construction activity summaries are incredibly valuable in reporting status and/or conditions of a construction project to upstream parties, such as, but not limited to, subcontractors, general contractors, owners, financiers, among other parties. Additionally, construction activity summaries may be required for compliance with local regulations on construction projects, such that a proper record is maintained of project conditions, which may be needed as proof or evidence in any future proceedings (e.g., lawsuits, compliance actions, inspections, zoning hearings, among other proceedings). Further still, construction activity summaries are highly valuable to both managers and investors/owners to understand how a project is proceeding and whether it may need changes.

The information contained in such construction activity summaries may include, but is not limited to including, progress and/or quantity installed updates within a given timeframe, quality updates within a given timeframe, finance updates within the given timeframe, schedule updates within the given timeframe, safety updates within the given timeframe, scope updates within the given timeframe, crew and labor count updates within the given timeframe, delivery report within the given timeframe, among other desired updates within the given timeframe. Specific examples of progress and/or quantity installed updates may include, but are not limited to including, the assessment of how much of a project is completed, cubic yards of soil extracted, the number of the glass panels installed, the number of coats of paint applied, etc. Quality updates may include, but are not limited to including, assessments of the quality of a completed construction task by a supervisory party to the task (e.g., “A faucet installation was performed on time with minimal to no water damage, as seen after the plumbing contractor finished.”). Finance updates may include, but are not limited to including, updates associated with any payment, billing, invoicing, or other financial tasks and/or discrepancies from the norm (e.g., “Invoice was received from the electrical contractor and timely paid in advance of the 30-day deadline.”). Schedule updates may include, but are not limited to including, changes to the schedule of one or more construction tasks, wherein said schedule changes occurred during the given timeframe (e.g., “Roofing contractors are delayed from commencement by two weeks, due to unavailability of roofing materials.”); further, schedule updates may also include affirmation that a task was performed on time (e.g., “The plumbing contractor finished all internal plumbing on the property, in accordance with the master schedule.”). Safety updates may include, but are not limited to including, documentation of inconsistencies or non-compliance with safety best practices, guidelines, and/or local regulations (e.g., “Roofing contractors are under review for non-compliance with safety regulations (e.g., multiple workers not wearing hard hats)”); further, safety updates may also include affirmation that a task was performed in accordance with safety best practices, guidelines, and/or local regulations (e.g., “The plumbing contractor completed his tasks in compliance with all pipefitters union best practices and local regulations.”). Scope updates may include, but are not limited to including, documentation in change of scope of an individual construction task, of the construction project (e.g., “Owners have requested that the electrical contractor install additional outlets in the basement, proximate to the ceiling, for hanging powered speakers”), or a global change in scope to the construction project (e.g., “Owner has requested, because we are running under budget, to add a three-seasons room, adjacent to the deck, and to move installation of the sliding door to an entrance to the three-seasons room”). Other updates may include, but are not limited to including, weather updates, guest/visitor attendance updates, building material change updates, equipment updates, among other updates valuable to a party to a construction project.

With such a wide array of data associated with a construction project, it is, understandably, a very time consuming and difficult task for an individual or group to compile this data, when the same individual or group is also responsible for executing construction tasks for the construction project. To that end, due to the breadth of data to be sifted through for the summaries, some important data points may be accidentally omitted, due to the oversampling of information used by the summary generating party. Further still, the risk of human error will exist, when having an individual or small group producing said summaries. Additionally, if the data is not properly organized, standardized, and/or commonly held, then there is a risk of omission of information, simply because the summary-compiling party does not have access to certain information. Further still, a summary may provide a man-power and/or labor or crew count report, which is important for tracking which subcontractor arrived on site on a particular day or when a subcontractor arrived last on site, to understand if and/or why the lack of progress of certain tasks are labor related.

To that end, computer-based services for aiding in planning and executing aspects of a construction project, such as those developed and maintained by Procore Technologies, may be of assistance to parties compiling said summaries. One or more applications of a construction management software service may be useful in both ingesting and compiling data for use in the preparation of construction activity summaries. Such applications include, but are not limited to including, scheduling applications, timesheet applications, request for information (RFI) applications, change order applications, conversations or messaging applications, construction project punch list applications, financial applications (e.g., budget applications, invoicing applications, payment processors, etc.), architectural and/or structural design applications, among other known applications within a construction management software service, such as those developed and maintained by Procore Technologies.

For example, a party compiling a construction activity summary may use data from scheduling and timesheet tools to assess the timeliness of a construction task by reviewing the time entries against the schedule to determine whether planned work is being performed on time. In another example, a party compiling a construction activity summary may use data from an RFI tool to assess one or more of safety, scope, and/or quality of a construction task by reviewing the nature of RFIs and the resultant information provided in the response to the RFI. In another example, a party compiling a construction activity summary may review messages received and/or sent within a conversations application to determine information associated with a construction task, by reviewing conversations amongst the team and determining status based on the conversations. Data from a punch list application may be used to assess quality of an ongoing construction task, quality of a performed construction task, among other observations that could be useful in a construction activity summary. Financial applications may also be useful in reviewing financial data and providing updates for the construction activity summary related to payment and/or non-payment for services rendered during the timeframe of the construction activity summary. Further, a party compiling a summary may review any changes to data within an architectural or structural design application, to determine, for example, changes in scope to the project, for inclusion in the construction activity summary.

However, there are still drawbacks even when utilizing a computing platform for gathering and compiling this information. For example, the use of such a wide breadth of information from, for example, the above-mentioned applications, may overwhelm or “over-inform” the party who is using the computing platform to gather information for compiling the construction activity summary—leading to additional time spent sifting through the wealth of information. Additionally, while use of such a construction management software service may prevent the loss of information that would be more likely to occur from manual documentation, merely using a computing platform for access to data may not mitigate human error or general forgetfulness when a compiling party generates a summary (e.g., the compiling party uses the construction management software service for data collection, but omits conversations data because he/she/they forget to review conversations within the given time frame).

Further still, even if the compiling party of a construction activity summary does not omit the review of any data sources, he/she/they still may lack certain knowledge that may be beneficial in generating the construction activity summary. For example, the compiling party may lack industry-level insight based on other, comparable projects that have been performed, either by the compiling party or another organization. Accordingly, due to a lack of contextual knowledge within the broader industry, a compiling party may not be best equipped to highlight the most important aspects of the construction activity summary, such that the reader of the construction activity summary is focused on the most important issues. To that end, even if a human user did prepare a completely accurate construction activity summary, he/she/they may not be fully equipped to identify anomalies in the construction activity summary that may lead to one or more of schedule, budget, safety, quality, and/or scope risks for the project.

To that end, the new technologies disclosed herein aim to utilize a computing platform and data collected thereon to improve, simplify, automate, prioritize, and/or optimize the generation of construction activity summaries. The computing platform, such as a computing platform installed with one or more construction management software services, may utilize the data collected from applications and/or application program interfaces (APIs) thereof to assist in generating construction activity summaries for a given timeframe. An “API,” as defined herein, refers to an interface for one or more computer programs to communicate with another, which offers some service or functionality to the other program(s). For example, an API associated with an RFI application may provide RFI data, that was previously input to the RFI application, to a construction activity summary generation application, for use in construction activity summary generation.

For implementing automatic construction activity summary generation within a computing platform, various systems, software, and/or databases utilizing machine learning and/or artificial intelligence (AI) can be leveraged for intelligent ingestion and processing of construction project information. For example, machine learning models can be utilized to ingest new data that is generated throughout the planning, design, and implementation phases of a construction project and associate that data with events that may be useful in generating construction activity summaries. Such data can be in the form of, but not limited to, text, drawings, photos, audio, transcripts, videos, 3-dimensional (3-D) models, and sensor data.

As a precursor to generating construction activity summaries, a computer vision model can be used to interpret what is captured within photos and convert it into text as input to the LLM. Similarly, an anomaly detection model can be used on a stream of IoT sensor data and generate a textual input to the LLM model for construction activity summarization consideration.

Of particular use in generating construction activity summaries, the specific machine learning models and/or techniques may relate to forms of natural language processing (“NLP”). NLP, generally, refers to an interdisciplinary field of linguistics and computer science that is concerned with processing natural language datasets, such as text corpa or speech corpa, using either rule-based or probabilistic machine learning methods. The aim of NLP is to generate models that are capable of understanding the context and meaning of data that is ingested by the model, such that the NLP model can “learn” the language or contextual meaning of terms and/or language. Thus, when utilizing machine learning models that employ NLP in generating construction activity summaries, by training the model based on historic construction project data held in the computing platform, it will “learn” the contextual nuances of the construction projects and/or the industries thereof.

While, generally, NLP is useful for automatic generation of construction activity summaries, new technologies in the field of large language models (LLMs) have the potential to generate even more accurate and optimized construction activity summaries. A LLM refers to a complex machine learning model that utilizes AI accelerator hardware to process vast amounts of text data, which may be scraped from a variety of sources, such as, but not limited to, the Internet. LLMs utilize artificial neural networks comprising millions or even billions of weights, which are then used for one or more of self-supervised learning, semi-supervised learning, or combinations thereof. LLMs operate by taking an input text and repeatedly predicting the next word input by the input text; the LLM can then review the input text versus the predictions to rank its accuracy and “learn” how to “speak” in the context of the scenario of the input text. Examples of LLMs include, but are not limited to including, Generative Pre-trained Transformer (GPT) models (e.g., GPT-3, GPT-3.5, GPT-4, ChatGPT), pathways language models (PaLM), Large Language Model Meta AI (LLaMA), BigScience Large Open-science Open-access Multilingual Language Model (BLOOM), Bidirectional Encoder Representations from Transformers (BERT), among other known models and/or techniques.

One particular example of a useful architecture for machine learning and/or LLM generation is the transformer model or architecture. Transformer models utilize an attention mechanism to determine key points of context within language datasets. For example, transformer models may split a language data stream into encoded tokens, which are converted to vectors via lookup in a word embedding table of the transformer model; then, each token is contextualized within the model to determine key tokens to be amplified and lesser tokens to be diminished. In other words, transformer models “transform” text into data points, which then can be compared with similar text data to determine the importance of each section of the data, for use in future predictions or generation of text.

Thus, as LLMs are immensely useful in both predicting text and automatically generating content based on a contextual input, the systems and methods disclosed herein utilize LLMs in automatically generating construction activity summaries, by leveraging data input to a computing platform associated with one or more construction management software services. The data input to the computing platform that is leveraged by the LLM may include both historic construction project data (e.g., historic construction project data associated with the current user and/or other users of the platform) and construction project data associated with a current, ongoing construction project, for which the construction activity summary fora given timeframe is generated.

By utilizing historic construction project data that has been previously input to the computing platform, the LLM is trained with the contextual language and contextual data that is specific to the construction management software service and the various construction-based industries that use it. For example, the LLM will “learn” the language of the various construction applications provided by the platform, including the general language of the construction industries themselves (e.g., specific construction trades such as plumbing, electrical, concrete, etc.). In this way, the LLM may be enabled to predict and/or generate text that is comparable to text that would be provided by a worker who, historically, compiled the construction activity summaries.

Further still, in the course of generating said summaries, the LLM may be retrained upon each new input to the computing platform. Additionally, the LLM may re-ingest the output data, which may or may not include user modification, and learn various restraints/parameters (e.g., rankings of importance, ordering of data, etc.). For instance, the computing platform and/or an application for generating said construction activity summaries may provide a means for the user to provide input associated with the generated summary, such as, but not limited to an approval that the summary is accurate, a disapproval of the summary, text edits and/or ordering edits to the summary, among other forms of user input associated with the generated summary. The LLM may then ingest the edits, learn from the edits, and be able to better predict what the user wants from his/her/their summaries, by learning from, for example, how the user ranks the importance of aspects of the summary.

Training and/or retraining of an LLM, as disclosed herein, may include fine-tuning an LLM based on the specific data sets associated with, for example, a construction management platform. To that end, “fine tuning,” generally refers to a process of re-training a more generic, pre-trained LLM, based on a specific dataset; said fine-tuning may allow the LLM to adapt to the specific context of an industry and/or platform. For example, training and/or re-training of the LLMs, disclosed herein, may include fine tuning the LLM based on specific, construction-based data sets. By employing such fine-tuning of an LLM, the LLM may be configured to “speak” the language of a specific industry and/or computing platform, such as the construction industry and/or a computing platform associated therewith.

Additionally, as the LLM will have been trained to understand the form and contextual meaning of various forms of data on the construction management platform, it may have capabilities for determining discrepancies in data or actions performed in the construction project, based on its learnings from the ingestion of historical construction data. For example, an invoice sent out during the timeframe for the generated construction activity summary may be flagged, in the construction activity summary by the LLM, as improper. In this example, the LLM may predict that the invoice is improper by comparing the invoice amount (e.g., $10,000) versus historical, similar invoices (e.g., generally in the range of $1,000) and determining the invoiced cost is far too high. In the construction activity summary, or as a separate notification, the LLM may indicate that someone should review the invoice and may even indicate the likely cause of the discrepancy (e.g., an extra zero may have been added to the invoices amount by accident.).

Additionally, the LLM can provide possible causes to certain delays and quality issues and have the users provide feedback so the LLM can continue to learn from user input, which, in turn, will enable the LLM to provide more accurate predictions. For example, the LLM can suggest the cause of a delay is likely due to the lack of materials delivered on-site, or the lack of a crew arriving on a given day, or that the weather was too hot and therefore workers' productivity are reduced, and more breaks are typically required.

In some examples of the disclosed technology, data generated for the construction activity summaries may be utilized by the construction management software services and/or one or more APIs thereof for automating tasks which, normally, are performed by users on the computing platform. In other words, the computing platform may utilize the construction activity summaries and the LLM to generate self-instructions to perform actions via the platform, which may have otherwise been executed via input from a user on an interface of one or more applications of the computing platform. For example, a generated construction activity summary may indicate that there is a discrepancy between the electrical wire gauge installed in a home, during a construction project, and the electrical wire gauge that was listed in the plans for the construction project. Based on this information, the computing platform may utilize the LLM to instruct an API associated with an RFI application to generate an RFI, to request information from the electrical contractor, regarding the discrepancy in electrical wire gauge in the construction project. In such examples, where a construction management application and/or API are instructed to generate data objects on the computing platform, the generated data objects may be edited, approved, and/or disapproved, via user input. As noted above, such user input may then be utilized by the LLM for further learning and predicting.

The technologies disclosed herein are particularly useful in streamlining the construction activity summary generation process, which, as described above, can be overly time consuming and prone to human error. Accordingly, by utilizing automatic summary generation, not only is time saved, but it can be utilized as a form of intelligent task management for the parties that would, generally, be responsible for generating said construction activity summaries. Some of these summaries examples includes Construction Daily reports, Monthly OAC (Owner Architect Contractor) reports, Monthly and Quarterly Progress report for owners, and project hand off/hand over to Owner near the completion of the project. Further, as LLMs are incredibly useful for ranking importance within a given dataset, the systems and methods disclosed herein are particularly useful in ranking the importance of tasks, within a construction activity summary, based on context-based inferences associated with one or more of the user, the project, or the construction industry in general. Finally, as always, within the construction industry, any tool that saves time for a worker will, naturally, have a cost-based benefit.

LLMs and/or machine-learning, generally, can be used to aggregate project events that are most relevant to the user. This allows the user to understand everything that has happened on the jobsite since they last looked, in a sequential manner. Previously, the user relied on narratives from people or aggregations of events, which have occurred and/or have been documented across different tools or software systems. Both are difficult to do without errors. Furthermore, introducing sequential weighting to jobsite events allows for a prioritization in the sequencing of activities that appear to the user. In other words, the event that have been determined to be the most relevant appear first. Urgent events, such as safety incidents, are, accordingly, noticed more quickly. There are many actionable events on the jobsite and this technology helps determine which ones are the most important, rather than defaulting to presenting, to a user, the event that happens first.

The disclosed technologies and use of LLMs, for the purposes of construction management and/or predicting actions for construction projects, may be leveraged for other, productivity gains. For example, by training a LLM with both user and LLM generated construction activity summaries, the LLM may use the trained data derived from the construction activity summaries to predict future daily reports, before the day of the report even occurs. As the LLM ingests more construction activity summaries, it will become more accurate at predicting what has or will happen, during a construction project. Thus, users of the construction management platform can gain intelligent insight for planning their next tasks, based on predictive reports generated by the LLM. Further still, the LLM may have abilities to determine whether or not and/or where gaps in data exist, when compiling a construction project summary, and request and/or automatically generate a process for obtaining information to fill said gap (e.g., generate or suggest generation of an RFI, generate or suggest generation of a change order, generate or suggest generation of a schedule change, and the like).

Further still, by ingesting multiple user and/or LLM generated construction activity summaries and/or other timely, contextual data sources (e.g., meeting minutes, timelines, daily plans, and the like), the construction management platform may be capable of utilizing the LLM to predict future next actions for the construction project. Such predictive modeling may be useful in identifying and/or assessing risk associated with projected outcomes and, for example, trigger the LLM to output suggestions to correct course to mitigate risk. To that end, the information gathered and processed by the LLM may be useful in automatically generating an optimized schedule, which may optimize the sequence of events in a construction project, to benefit of the project (e.g., minimizing risk in the project, completing the project quicker, optimizing equipment use/delivery, etc.).

In another aspect, the LLM can also identify the action items within the ingested data sources (e.g. meeting minutes, or a chat conversation), and determine, upon a future date, if such action items have been completed. The LLM may perform said actions by identifying a related completion statement of the future ingested data sources, and, therefore, send reminders to help individuals who were assigned such action item. Such an implementation of an LLM may hold entities associated with the construction project accountable, while, me also identifying such uncompleted action items as a risk to the project.

In line with the discussion above, the disclosed technology may be implemented as one or more software applications that facilitate the creation and management of data during the course of a construction project, some examples of which may include the types of software applications developed by Procore Technologies. Further, in practice, the computing platform in which the disclosed technology is incorporated may take the form of a software as a service (“SaaS”) application that comprises a front-end software component running on a user's client station or end-user device and a back-end software component running on a back-end computing platform that is accessible to the user client station or end-user device via a communication network such as the Internet.

In one aspect, disclosed herein is a method that involves a computing platform (i) training a large language model (LLM) by carrying out a first machine learning process on a first training data set that includes first construction-based data associated with one or more of a user, a plurality of reference construction projects, a construction-based application of the computing platform, or combinations thereof, wherein the LLM is configured to (a) receive, as input, construction project data associated with an ongoing construction project, (b) receive, as input, a context-based prompt, and (c) based on an evaluation of the context-based prompt in view of, at least, the first training data set and the construction project data, output a contextual response to the context-based prompt, (ii) receiving a request to generate a construction activity summary for the ongoing construction project, the construction activity summary associated with a given timeframe of the ongoing construction project, the request including the context-based prompt, (iii) generating the construction activity summary by inputting the request into the LLM, the construction activity summary including the contextual response, (iv) causing a client device to present a first interface to a user, the first interface usable for one or more of viewing the construction activity summary, editing the construction activity summary, or combinations thereof, (v) receiving input associated with the construction activity summary, via the first interface, and (vi) retraining the LLM by carrying out a second machine learning process on a second training data set that includes (i) the first training data set and (ii) one or more of the context-based prompt, the construction project data, the evaluation, the contextual response, the construction activity summary, the given timeframe, the request, the input, or combinations thereof.

In another aspect, disclosed herein is a computing platform that includes a network interface, at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

In yet another aspect, disclosed herein is a non-transitory computer-readable storage medium provisioned with software that is executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3 depicts a structural diagram of an example end-user device that may be configured to communicate with the example computing platform of FIG. 2 and also carry out one or more functions in accordance with the disclosed technology.

FIG. 4 depicts a flow diagram of an example process for automatically generating summaries related to a construction project, according to one possible implementation of the disclosed technology.

FIG. 5 depicts an example diagram illustrating aspects of a large language model (LLM) utilized in conjunction with the process of FIG. 4, according to one possible implementation of the disclosed technology.

FIG. 6 depicts a flow diagram of an example process for automatically generating one or more information category of a summary related to a construction project, as an implementation, in part, of the process of FIG. 4, according to one possible implementation of the disclosed technology.

FIG. 7A depicts an example graphic interface utilized in generating a construction activity summary utilizing the process of FIGS. 4-6, according to one possible implementation of the disclosed technology.

FIG. 7B depicts another example graphic interface utilized in generating a construction activity summary utilizing the process of FIGS. 4-7A, according to one possible implementation of the disclosed technology.

FIG. 8A depicts an example graphic interface utilized in executing a solutions engine in conjunction with a summary generated via the process(es) of FIGS. 4-7B, according to one possible implementation of the disclosed technology.

FIG. 8B depicts another example graphic interface utilized in executing a solutions engine in conjunction with a summary generated via the process(es) of FIGS. 4-8A, according to one possible implementation of the disclosed technology.

FIG. 9 depicts a flow diagram of an example process for retraining the LLM of FIGS. 4-8B, as an implementation, in part, of the process of FIG. 4, according to one possible implementation of the disclosed technology.

FIG. 10 depicts an example diagram illustrating aspects of a retrained LLM, utilized in conjunction with the process(es) of FIGS. 4-9, according to one possible implementation of the disclosed technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example Network Configuration

As one possible implementation, this software technology may include both front-end software running on one or more end-user devices that are accessible to users of the software technology and back-end software running on a back-end computing platform (sometimes referred to as a “cloud” platform or a “data” platform) that interacts with and/or drives the front-end software, and which may be operated (either directly or indirectly) by a provider of the front-end client software (e.g., Procore Technologies, Inc.). As another possible implementation, this software technology may include front-end client software that runs on end-user devices without interaction with a back-end platform (e.g., a native software application, a mobile application, etc.). The software technology disclosed herein may take other forms as well.

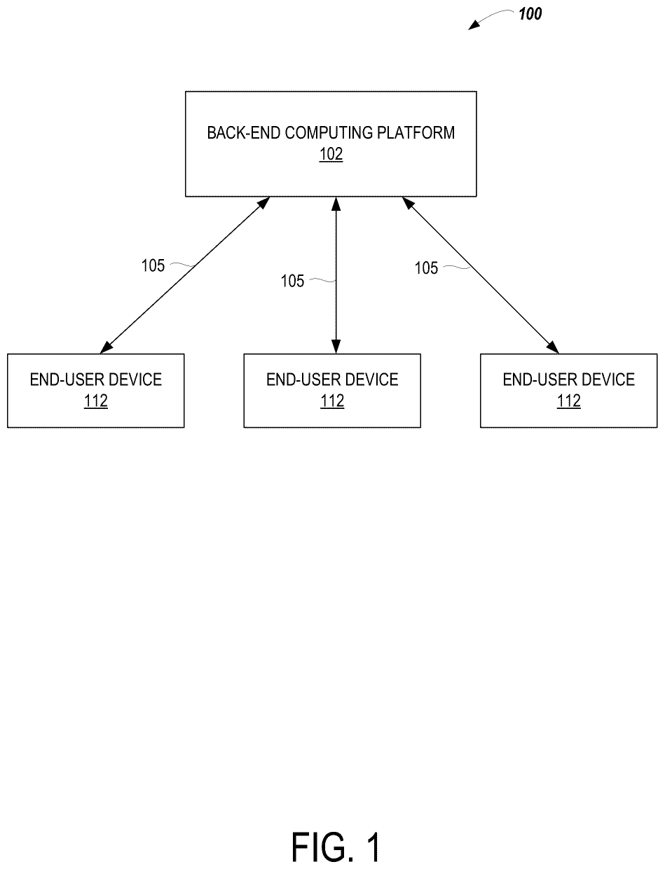

Turning now to the figures, FIG. 1 depicts an example network configuration 100 in which example embodiments of the present disclosure may be implemented. As shown in FIG. 1, the network configuration 100 includes an example back-end computing platform 102 that may be communicatively coupled to one or more client stations, depicted here, for the sake of discussion, as three end-user devices 112.

In practice, the back-end computing platform 102 may generally comprise some set of physical computing resources (e.g., processors, data storage, communication interfaces, etc.) that are utilized to implement the new software technology discussed herein. This set of physical computing resources may take any of various forms. As one possibility, the back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform 102 may comprise “on-premises” computing resources of the organization that operates the back-end computing platform 102 (e.g., organization-owned servers).

As yet another possibility, the back-end computing platform 102 may comprise one or more dedicated servers have been provisioned with software for carrying out one or more of the computing platform functions disclosed herein, including but not limited to functions related to generating one or more of data objects, public conversation threads, limited conversation threads, or combinations thereof, facilitating conversations and/or data sharing, via the end-user devices 112, among other communications related functions. The one or more computing systems of the back-end computing platform 102 may take various other forms and be arranged in various other manners as well.

In turn, end-user devices 112 may take any of various forms, examples of which may include a desktop computer, a laptop, a netbook, a tablet, a smartphone, and/or a personal digital assistant (PDA), among other possibilities.

As further depicted in FIG. 1, the back-end computing platform 102 may be configured to communicate with the end-user devices 112 over respective communication paths 105. Each communication path 105 between the back-end computing platform 102 and an end-user device 112 may generally comprise one or more communication networks and/or communications links, which may take any of various forms. For instance, each respective communication path 105 with the back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 105 with the back-end computing platform 102 may be wireless, wired, or some combination thereof, and may carry data according to any of various different communication protocols. Although not shown, the respective communication paths with the back-end computing platform 102 may also include one or more intermediate systems. For example, it is possible that the back-end computing platform 102 may communicate with a given end-user device 112 via one or more intermediary systems, such as a host server (not shown). Many other configurations are also possible.

Although not shown in FIG. 1, the back-end computing platform 102 may also be configured to receive data from one or more external data sources that may be used to facilitate functions related to the processes disclosed herein. For example, the back-end computing platform 102 may be configured to generate conversation threads and facilitate conversations thereon, as discussed herein.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Computing Devices

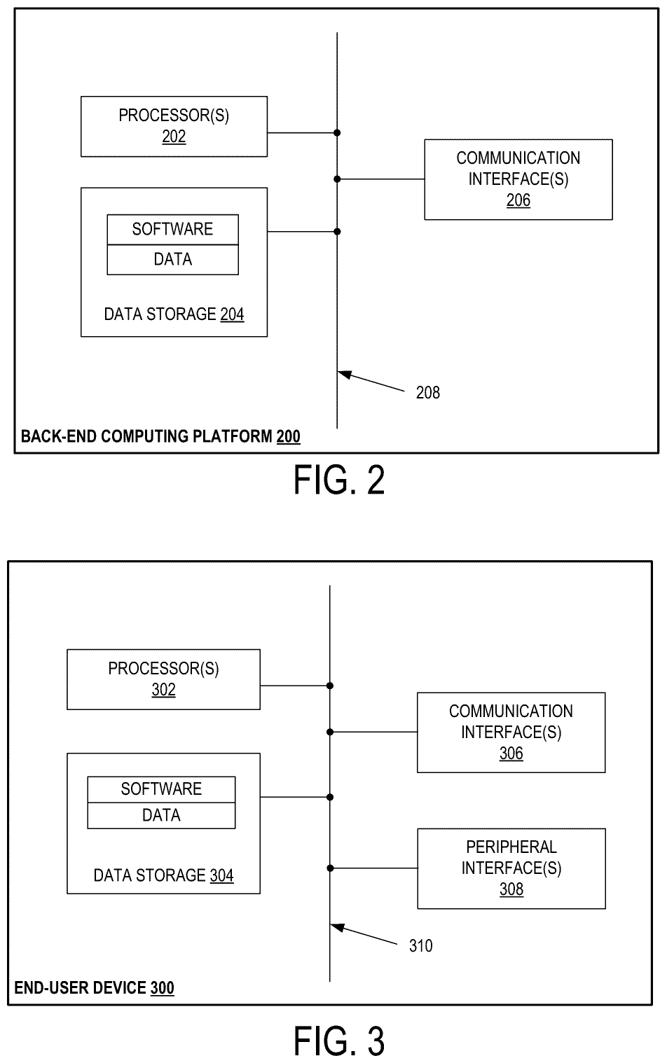

FIG. 2 is a simplified block diagram illustrating some structural components that may be included in an example computing platform 200. The example computing platform 200 could serve as, for instance, the back-end computing platform 102 of FIG. 1 that may be configured to automatically generate summaries of construction projects, by utilizing Large Language Models (LLMs) and/or executing one or more application program interfaces (APIs), based on automatically generated summaries. In line with the discussion above, the computing platform 200 may generally comprise one or more computer systems (e.g., one or more servers), and these one or more computer systems may collectively include at least one or more processors 202, a data storage 204, and one or more communication interfaces 206, all of which may be communicatively linked by a communication link 208 that may take the form of a system bus, a communication network such as a public, private, or hybrid cloud, or some other connection mechanism.

The one or more processors 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the one or more processors 202 could comprise processing components that are distributed across a plurality of physical computing resources connected via a network, such as a computing cluster of a public, private, or hybrid cloud.

In turn, the data storage 204 may comprise one or more non-transitory computer-readable storage mediums that are collectively configured to store (i) program instructions that are executable by the one or more processors 202 such that the computing platform 200 is configured to perform some or all of the disclosed functions and (ii) data that may be received, derived, or otherwise stored, for example, in one or more databases, file systems, or the like, by the computing platform 200 in connection with the disclosed functions. In this respect, the one or more non-transitory computer-readable storage mediums of the data storage 204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing resources connected via a network, such as a storage cluster of a public, private, or hybrid cloud. Data storage 204 may take other forms and/or store data in other manners as well.

The one or more communication interfaces 206 may be configured to facilitate wireless and/or wired communication with external data sources and/or end-user devices, such as the end-user devices 112 in FIG. 1. Additionally, in an implementation where the computing platform 200 comprises a plurality of physical computing resources connected via a network, the one or more communication interfaces 206 may be configured to facilitate wireless and/or wired communication between those physical computing resources (e.g., between computing and storage clusters in a cloud network). As such, the one or more communication interfaces 206 may take any suitable form for carrying out these functions, examples of which may include an Ethernet interface, a serial bus interface (e.g., Firewire, USB 3.0, etc.), a chipset and antenna adapted to facilitate wireless communication and/or any other interface that provides for wireless communication (e.g., Wi-Fi communication, cellular communication, short-range wireless protocols, etc.) and/or wired communication, among other possibilities. The one or more communication interfaces 206 may also include multiple communication interfaces of different types. Other configurations are possible as well.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the computing platform 200.

It should be understood that the computing platform 200 is one example of a computing platform that may be used with the embodiments described herein. Numerous other arrangements are possible and contemplated herein. For instance, other computing platforms may include additional components not pictured and/or more or less of the pictured components.

Turning now to FIG. 3, a simplified block diagram is provided to illustrate some structural components that may be included in an example end-user device 300, such as an end-user device 112 described above with reference to FIG. 1. As shown in FIG. 3, the end-user device 300 may include one or more processors 302, data storage 304, one or more communication interfaces 306, and one or more user-interface components 308, all of which may be communicatively linked by a communication link 310 that may take the form of a system bus or some other connection mechanism. Each of these components may take various forms.

The one or more processors 302 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 304 may comprise one or more non-transitory computer-readable storage mediums that are collectively configured to store (i) program instructions that are executable by the processor(s) 302 such that the end-user device 300 is configured to perform certain functions related to interacting with and accessing services provided by a computing platform, such as the example computing platform 200 described above with reference to FIG. 2, and (ii) data that may be received, derived, or otherwise stored, for example, in one or more databases, file systems, repositories, or the like, by the end-user device 300, related to interacting with and accessing the services provided by the computing platform. In this respect, the one or more non-transitory computer-readable storage mediums of the data storage 304 may take various forms, examples of which may include volatile storage mediums such as random-access memory, registers, cache, etc., and non-volatile storage mediums such as read-only memory, a hard-disk drive, a solid-state drive, flash memory, an optical-storage device etc. The data storage 304 may take other forms and/or store data in other manners as well.

The one or more communication interfaces 306 may be configured to facilitate wireless and/or wired communication with other computing devices. The one or more communication interfaces 306 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The end-user device 300 may additionally include or have interfaces for one or more user-interface components 308 that facilitate user interaction with the end-user device 300, such as a keyboard, a mouse, a trackpad, a display screen, a touch-sensitive interface, a stylus, a virtual-reality headset, and/or one or more speaker components, among other possibilities.

It should be understood that the end-user device 300 is one example of an end-user device that may be used to interact with a computing platform as described herein. Numerous other arrangements are possible and contemplated herein. For instance, in other embodiments, the end-user device 300 may include additional components not pictured and/or more or fewer of the pictured components. Further, the end user device 300 of FIG. 3 and/or the end user device 112 of FIG. 1 may be examples of client devices, utilized by users of the computing platform 200.

### III. Example Operations

As mentioned above, Procore Technologies has continued to develop software technology related to construction management and data management amongst platform users associated with such managed projects. Disclosed herein is new software technology that is generally directed to training a large language model (LLM), for use with a computing platform, utilizing the trained LLM to automatically generate construction activity summaries for an ongoing construction project, and, optionally, utilizing data from the generated construction activity summaries to execute an API of the computing platform to perform or assist in performing an action associated with the construction project. As disclosed herein, an “ongoing construction project,” may refer to a construction project that is currently being monitored by one or more entities (e.g., contractors, owners, supervisors, workers, etc.). Accordingly, such ongoing construction projects may be in any phase of the construction project, such as, but not limited to, a planning phase, a design phase, a logistics phase, a construction phase, an implementation phase, a finalization phase, among other known project phases for a construction project.

i. Systems and Methods of Generating Construction Activity Summaries for Ongoing Construction Projects by Utilizing an LLM

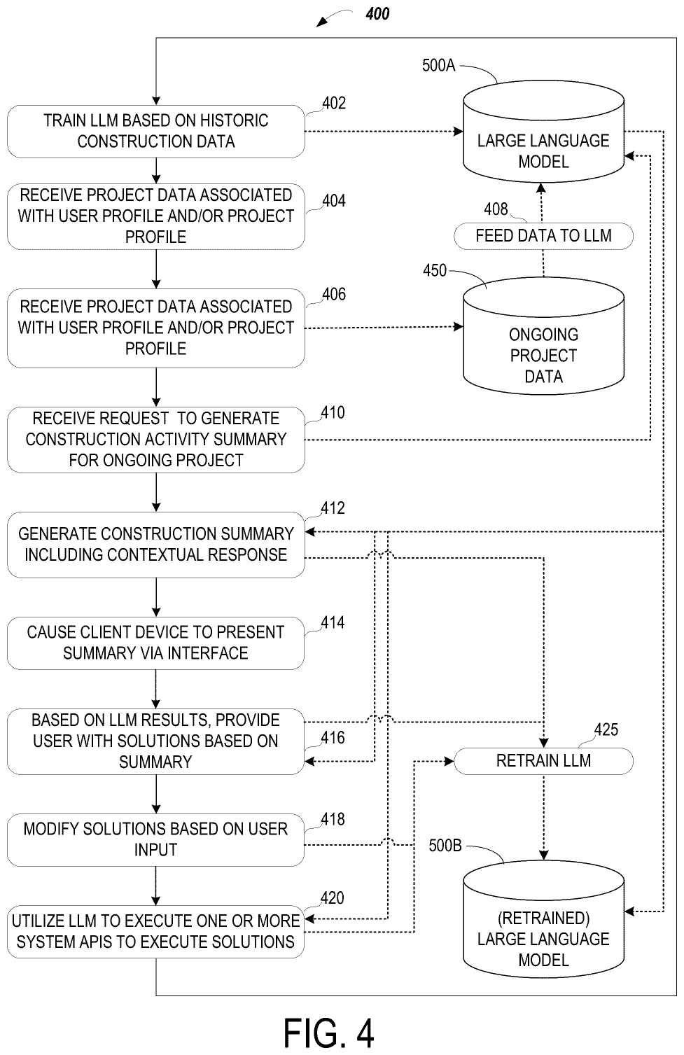

Turning now to FIG. 4, an example flow diagram is illustrated for a method 400 carried out by a computing platform, which may take the form of one or more of the back-end computing platform 102, 200, the end-user device(s) 300, or combinations thereof. The method 400 may begin at block 402, by training a LLM 500A based on, at least, historical or reference construction project data.

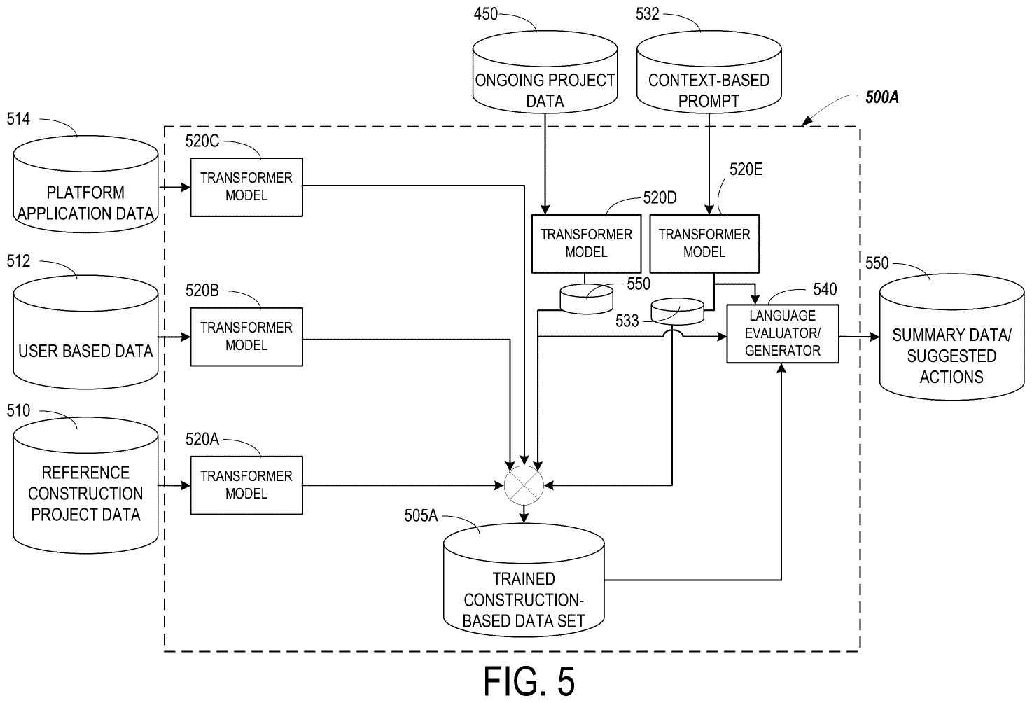

To that end, FIG. 5 is an example block diagram for the LLM 500A, components thereof, and associated data throughput. The LLM 500A may be implemented by one or more computing devices of the computing platform 200, the end-user devices 300, or combinations thereof. As illustrated, the LLM 500A receives reference construction project data 510 and utilizes the reference construction project data 510 in training the LLM 500A, based on one or more LLM training systems and/or methods known in the art. The reference construction project data 510 may be any construction project data related to past completed or other ongoing construction projects, which may be useful in training the LLM 500A to recognize context and language used within the confines of a computing platform 200 running a construction management software service, or any applications thereof. For example, the reference construction project data 510 may include inputs to one or more construction applications of the computing platform 200 and/or applications thereof, such as those mentioned above. Said data input to the computing platform 200 and utilized in the construction project data 510 may be prior construction data input by the immediate user of the computing platform 200 (e.g., via an end-user device 300), when executing the method 400. Additionally, or alternatively, the reference construction project data 510 may be construction project data that is entered by third party users of the computing platform 200 (e.g., via other end-user devices 300) and compiled by the LLM 500A for use in language processing and machine learning. In such examples, third party construction data may be anonymized by the computing platform 200 to remove any personally identifying information of the third party users of the computing platform 200.

Training the LLM 500A includes carrying out a machine learning process on a first training data set, which includes, at least, the construction-based data associated with the reference construction project data 510. The machine learning process may further be carried out on one or more of user-based data 512, and platform application data 514, when one or both are utilized in the first training data set. The user-based data 512 may be data that is specifically associated with the immediate user of the computing platform 200 and/or an associated client station, which may be an end-user device 300, and/or the user-based data 512 may include data associated with an organization (e.g., a contractor organization, an ownership organization, etc.) having access to the computing platform 200. The user-based data 512 may be useful, for training the LLM 500A, to tailor the output of the LLM 500A to a specific user and/or organization and their respective construction project. The platform application data 514 may be any data associated with a construction-based application of the computing platform 200, such as the construction-based applications discussed above (e.g., scheduling applications, timesheet applications, RFI applications, financial applications, punch list applications, communications applications, and the like).

Each of the reference construction project data 510, the user based data 512, and the platform application data 514 may be ingested by the LLM 500A, for the purposes of training the LLM 500A, and transformed into a trained construction-based data set 505A, by processing the data 510, 512, and 514 via one or more machine learning and/or natural language processing processes or methods. As illustrated in the example of FIG. 5, the data 510, 512, 514 may all be processed by one or more transformer models 520 to generate context-based tokenized versions of the data 510, 512, and 514, which may be ranked and utilized in training and/or in further retraining of the LLM 500A.

Training and/or subsequent retraining of the LLM 500A, as disclosed herein, may include fine-tuning the LLM 500A based on the specific data sets associated with, for example, a construction management platform. To that end, “fine tuning,” generally refers to a process of re-training a more generic, pre-trained LLM, based on a specific dataset; said fine-tuning may result in the LLM 500A to adapt to the specific context of an industry and/or platform. For example, training and/or re-training of the LLMs 500A, disclosed herein, may include fine tuning the LLM 500A based on specific, construction-based data sets, such as, but not limited to the data 510, 512, 514. By employing such fine-tuning of an LLM, the LLM may be configured to “speak” the language of a specific industry and/or computing platform, such as the construction industry and/or the computing platform 200 associated therewith.

Further, as illustrated in FIG. 5, the LLM 500A is configured to receive, as input, ongoing construction project data 450, which is associated with the immediate, ongoing construction project, for which the construction activity summary is generated. The LLM 500A is further configured to receive, as input, a context-based prompt 532. Based on an evaluation of the context-based prompt 532, in view of, at least, the trained construction-based data set 505A and the ongoing construction project data 450, the LLM 500A may utilize a language evaluator and/or generator 540 to output a contextual response to the context-based prompt.

A “context-based prompt,” generally refers to a prompt that may be processed by the LLM 500A as a written, language-based prompt for the LLM 500A to respond to with responsive language. For example, a context-based prompt, which may be input to the LLM 500A via user input, API input, or automated timed input, may be a request to generate a construction activity summary for a given timeframe of the construction project. A “contextual response” refers, generally, to a response output by the LLM 500A, which, generally, answers a context-based prompt, based on an evaluation of input data, with respect to a previously trained dataset for the LLM 500A. In the example above wherein the context-based prompt is a request to generate a construction activity summary for a given timeframe of the construction project, a contextual response to said prompt may be an automatically generated construction activity summary within the given timeframe of the construction project.

In some examples, the ongoing construction project data 450 and/or the context-based prompt 532 may be processed by respective transformer models 520D, 520E, either prior to or in advance of being evaluated at the language evaluator/generator 540. In some such examples, trained ongoing project data 550 and/or trained contextual prompt data 533 may be input to the trained construction-based data set 505A.

Returning now to FIG. 4 but with continued reference to elements of FIG. 5, the method 400 includes block 404, wherein the computing platform 200 receives the reference construction project data 510 and the user-based construction data 512. The platform application data 514 may, generally, be accessible by the computing platform 200. At block 406, the method 400 includes receiving the ongoing construction project data 450, which may be associated with one or more of a user profile associated with a user of the computing platform 200 or associated end user device 300, a project profile for the construction project, or combinations thereof. As illustrated and best described, above, with respect to FIG. 5, at block 408, the ongoing construction project data 450 is input to the LLM 500A.

At block 410, the method 400 includes receiving a request, at the computing platform 200, to generate a construction activity summary for the ongoing project. The request to generate the construction activity summary may be or may include a context-based prompt and the request is input to the LLM 500A, as discussed above. Then, after processing the context-based prompt at the LLM 500A, the method 400 includes generating the construction activity summary, which includes at least one contextual response to the context-based prompt, as illustrated in block 412.

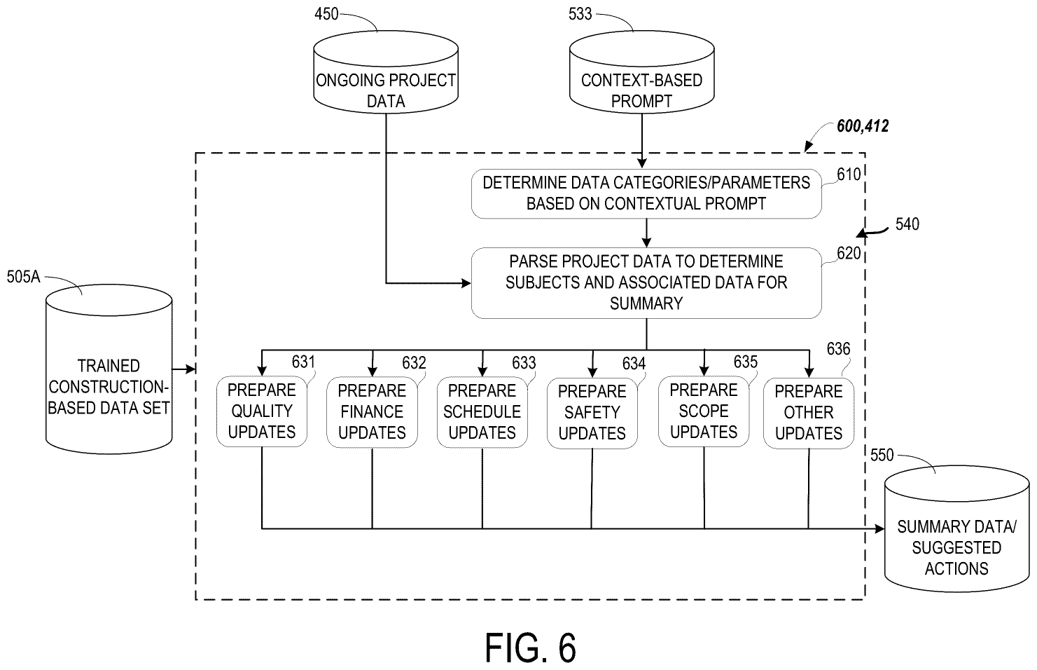

FIG. 6 is an example flowchart illustrating an example method 600 of generating the construction activity summary, utilizing, for example, the LLM 500A and/or the language evaluator/generator 540 thereof. The method 600 may be carried out, for example, by the computing platform 200 running the LLM 500A to execute the functions of block 412 of the method 400 of FIG. 4.

The method 600 includes determining what data categories and/or parameters are to be utilized in generating the contextual response, based on the context-based prompt, as illustrated in block 610. Thus, when the context-based prompt includes instructions to generate a construction activity summary for a given time frame, determining categories and parameters may include determining what are the most important parameters and/or categories for a response, based on ranking of importance that is determined during the training of the trained construction-based data set 505A. Thus, with categories/parameters for the construction activity summary determined, the method 600 may include utilizing the ongoing construction project data 450, in view of an evaluation with respect to the trained construction based data set, to determine and/or parse the ongoing construction project data 450 to determine the subjects and associated data for use in the construction activity summary, as illustrated in block 620.

Then, generally, the parsed data can be used to generate natural language for a plurality of updates for use in the construction activity summary and/or contextual response. For example and as illustrated, after block 620, the method 600 may include one or more of preparing quality updates for the construction activity summary (block 631), preparing finance updates for the construction activity summary 632, preparing schedule updates for the construction activity summary (633), preparing safety updates for the construction activity summary (block 634), preparing scope updates for the construction activity summary (block 635), preparing other updates for the construction activity summary (block 636), or combinations thereof. The output of blocks 631, 632, 633, 634, 635, 636 may then be intelligently ordered and/or organized by the LLM 500A, thereby generating a natural language, automated construction activity summary, output as summary data and/or suggested actions 550.

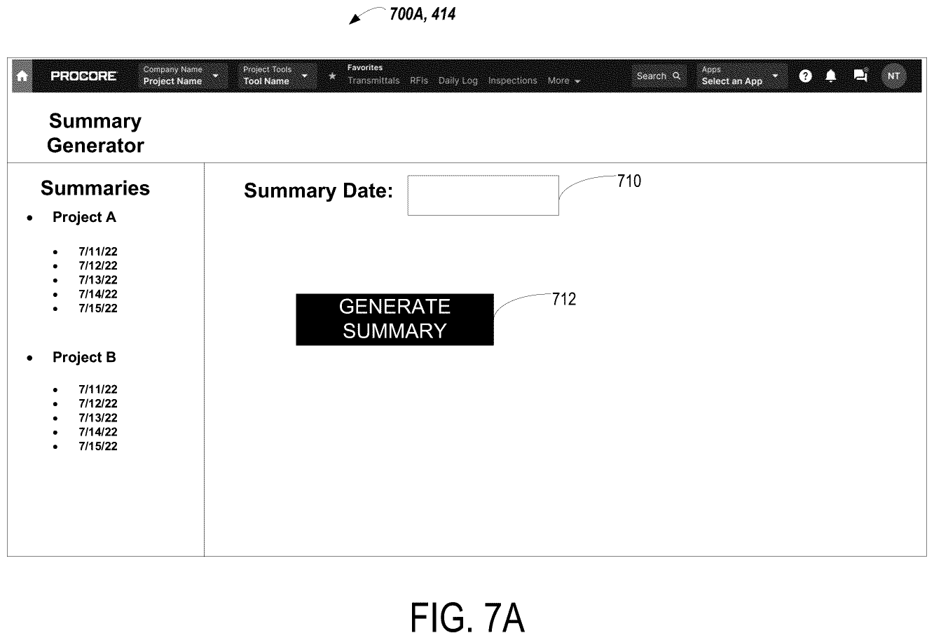

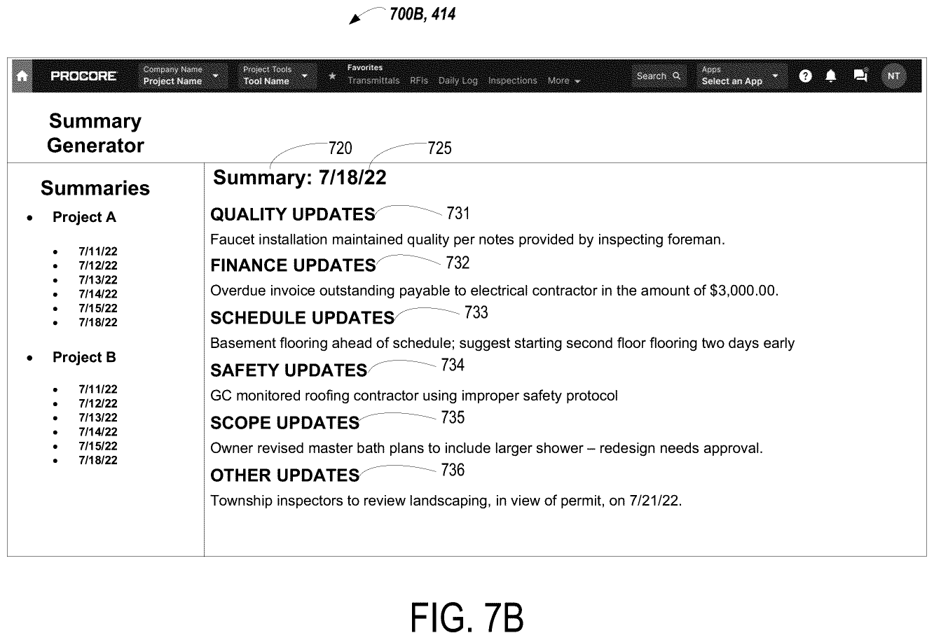

Returning now to FIG. 4, at block 414, the method 400 may further include causing a client station (e.g., an end-user device 300) to present the automatically generated construction activity summary to an end user of the computing platform 200. Regarding presentation of the construction activity summary, FIG. 7A illustrates an example interface 700A, which may be utilized for automatically generating construction activity summaries. As illustrated in FIG. 7A, the interface 700A is configured to accept a user input or prompt to automatically generate a user summary for the project, titled “Project Name.” For example, the interface 700A may ask the end user to input a requested timeframe or date for the requested summary, as illustrated by the input prompt 710 of the interface 700A. Then, the user may click or otherwise interface with a confirmation button, 712, via the client device, to send the request to generate the summary for the timeframe input in the input prompt 710. While illustrated as requiring user input, the illustrated interface 700 and/or an application it is associated with (e.g., a “Summary Generator” application) may not require user input and may automatically populate the timeframe or may automatically generate the summary, via API request or by automatic generation at a given frequency.

Further, FIG. 7B illustrates an example interface 700B, which illustrates a construction activity summary 720 for a given timeframe 725. The construction activity summary 720 may be generated in response to, for example, user input via the interface 700A, may be generated automatically for a given timeframe via an API, and/or may be automatically populated based on a scheduled frequency for generating summaries. As illustrated, the construction activity summary 720 may include, but is not limited to including, one or more of quality updates 731, finance updates 732, schedule updates 733, safety updates 734, scope updates 735, other updates 736, or combinations thereof.

ii. Utilizing Data from Generated Summary to Execute Solutions Engine

Returning now to FIG. 4, at block 416, the method 400 may further include providing the user with one or more of user suggestions, user solutions, or combinations thereof, based on the output of the LLM 500A. To that end, in some such examples, the computing platform 200 may cause an end-user device 300 to present a user suggestion to the user via an interface generated by the computing platform 200 and/or generated by the end-user device 300 in response to instructions from the computing platform 200. In such examples, the LLM 500A is further configured to receive, as input, the construction activity summary and, based on an evaluation of the construction activity summary, in view of training data sets, output a user suggestion. The user suggestions may be, for example, suggestions for new types of data to include in construction project summaries, suggestions for improving productivity, suggestions for mitigating risk associated with a category of data in the construction activity summary, among other things.

In some such examples, the computing platform 200 may be configured to execute one or more APIs to execute the suggested action. A suggested action may be any suggestion, generated by the LLM 500A, for performing an action during the construction project that will assist in optimizing performance of the work on the construction project, improve efficiency, mitigate risk in the construction project, correct errors in financial documentation, mitigate known safety concerns, among other things.

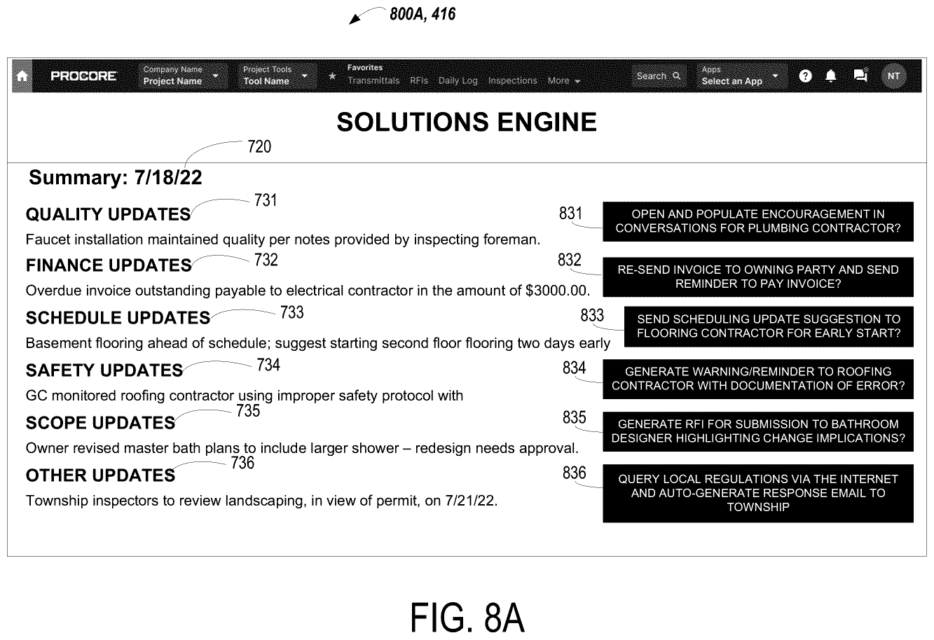

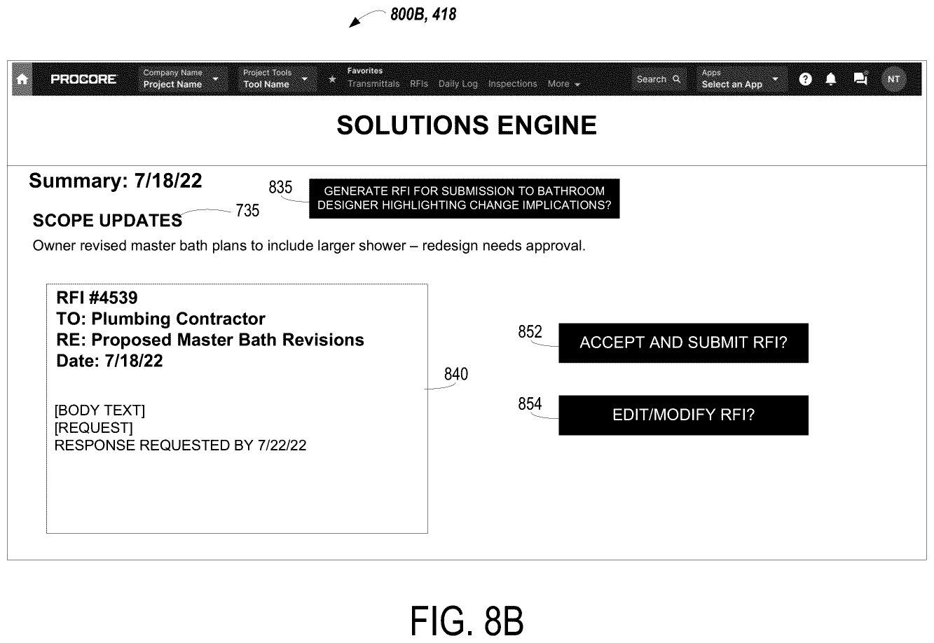

FIG. 8A illustrates an example interface 800A, which may be utilized for displaying suggested actions associated with the construction project. FIG. 8A illustrates an example wherein the computing system 200 provides a user, via the interface 800A on the end user device 300, with one or more suggested actions to perform, in view of the data in the generated construction activity summary 720. For example, the interface 800A may result from execution of the actions of block 416 of the method 400. The interface 800A may take the form of a “Solutions Engine” application, which utilizes output of the LLM 500A to automatically generate solutions to issues, which are predicted, based on the results of the automatic summary generation. As illustrated, the solutions engine of the interface 800A may output/present to a user a plurality of suggested actions 831, 832, 833, 834, 835, 836, where each of the suggested actions are associated with a respective update 731, 732, 733, 734, 735, 736 of the construction activity summary 720. As will be understood in the context of the contents of the text displayed in FIG. 8A, the two least significant digits of the reference number of each update 731, 732, 733, 734, 735, 736 corresponds to the two least significant digits of the reference number of each associated suggested action 831, 832, 833, 834, 835, 836, each suggested action 831, 832, 833, 834, 835, 836 generated in response to its respective update 731, 732, 733, 734, 735, 736.

Returning to FIG. 4, at block 418, the method 400 may include modifying the solutions and/or suggestions provided by the LLM 500A. In such examples, the computing platform 200 may be configured to cause an end-user device 300 to present the at least one suggested action to the user via an interface, receive user input, via the end-user device 300, associated with the at least one suggested action, and modify the at least one suggested action to generate a modified suggested action. With or without modification to the suggested action, in some examples, the method 400 includes executing one or more APIs (e.g., an API of a construction management software service) to execute the modified suggested action.

To further explain the functions of blocks 416, 418, and 420, FIG. 8B illustrates an example interface 800B, which may be utilized for performing one or more of the suggested actions associated with the construction project, via a solutions engine. As illustrated, the user, via the end-user device 300, has selected suggested action 835 via the interface 800A of FIG. 8A. As the text of suggested action 835 indicates, when selected, the solutions engine will generate an RFI. Accordingly, the LLM 500A generates the RFI 840, upon instruction to execute the suggested action 835. In some examples, the LLM 500A may provide instructions via an API of an RFI software tool to cause the RFI software tool to generate the RFI 840.

The interface 800B may facilitate user input via various selectable indications, which may include a first selectable indication 852 to accept and/or submit the generated RFI 840 and a second selectable indication 854, which may be selected and/or utilized for editing or otherwise modifying the RFI 840, prior to submission. Any inputs received via the interface 800B, including modifications to the LLM 500A generated RFI 840, will be fed into the LLM 500A, for the purposes of updating, improving, or otherwise retraining the LLM 500A based on the process of generating the construction activity summary and any suggested actions and/or user suggestions based thereon.

iii. Retraining the LLM Based on Data Generated During Summary Generation and/or Solutions Engine Execution

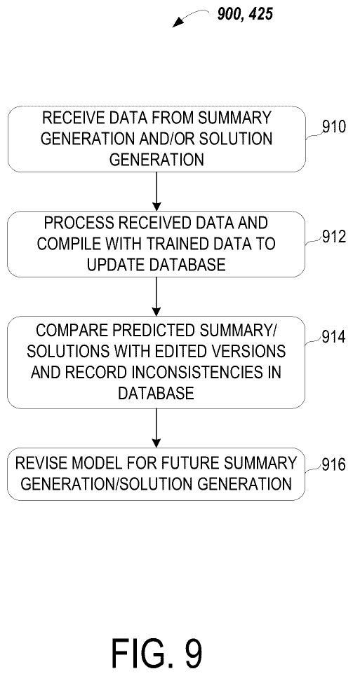

Returning now to FIG. 4, as illustrated, one or more of blocks 412, 416, 418, 420, or combinations thereof may produce data that is valuable in retraining the LLM 500A, resulting in a retrained LLM 500B, illustrated by arrows flowing from blocks 412, 416, 418, 420 to the retraining step of block 425, resulting in output of the retrained LLM 500B. To that end, FIG. 9 is an example flow diagram for a method 900 for retraining the LLM, based on data generated during the process of generating a construction activity summary and/or executing a solutions engine. For example, the method 900 may be utilized in executing the functions of block 425 of FIG. 4.

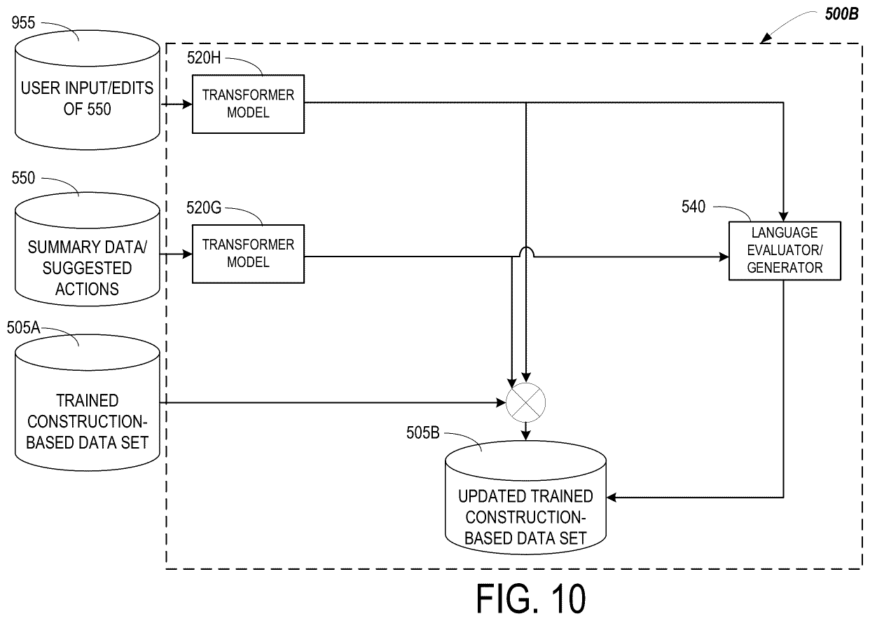

The method 900 begins with block 910, by receiving data at the LLM 500A based on one or more of the generation of the construction activity summary (e.g., data in the construction activity summary, itself and/or modifications thereof), generation of user suggestions and/or suggested actions (e.g., data including the actions/suggestions themselves and/or modifications thereof), or combinations thereof. To further illustrate this data input, FIG. 10 is an example block diagram for a retrained LLM 500B and/or a retraining process thereof, components thereof, and associated data throughput. As illustrated, the retrained LLM 500B receives one or more of the previous trained construction-based data set 505A of the LLM 500A, the summary data and/or suggested actions data 550, and any user inputs or edits data 955 of the summary data 550.

Returning to FIG. 9, but with continued reference to FIG. 10, as illustrated in block 912, the method 900 may include processing the received data 550, 955, and compiling the received data 550, 955 with the previously trained construction-based dataset 505A to begin generating an updated trained construction-based dataset 505B. In some examples, the received data 550, 955 may be processed by respective transformer models 520G, 520H, which may be like or similar transformer models to the transformer models 520A-F of FIG. 5.

In some examples, the method 900 may include comparing the predicted summary and solution data with the edits and/or edited data to determine inconsistencies and/or learning data points for improving the learning of the LLM 500B, as illustrated in block 914. Accordingly, all of the steps of the method 900 may ultimately be performed, along with other machine learning and/or natural language processing methods, to revise the LLM 500A and generate the retrained LLM 500B, for enhanced construction activity summary generation for future instances for one or more of the instant user of the computing platform 200, another third party or future user of the computing platform 200, or combinations thereof.

### IV. Conclusion

Example embodiments of the disclosed innovations have been described above. Those skilled in the art will understand, however, that changes and modifications may be made to the embodiments described without departing from the true scope and spirit of the present invention, which will be defined by the claims.

While the foregoing is described in the context of data objects related to construction projects, it should be understood that the disclosed technology may be utilized in connection with other kinds of data objects as well. For example, the disclosed technology may be utilized for generating limited conversation threads in connection with data objects associated with professional or business tasks and projects, data objects associated with academic tasks and projects, data objects associated with legal tasks and projects, data objects associated with interpersonal or social tasks or projects, and the like.

For instance, those in the art will understand that the disclosed operations for training and utilizing machine-learning models and/or LLMs in the manner described herein to generate action summaries and/or perform actions based on said generated action summaries, may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one network interface;
at least one processor;
at least one non-transitory computer-readable medium; and
program instructions stored on the at least one non-transitory computer-readable medium that are executable by the at least one processor such that the computing platform is configured to:
train a large language model (LLM) by carrying out a first machine learning process on a first training data set that includes first construction-based data associated with one or more of a user, a plurality of reference construction projects, a construction-based application of the computing platform, or combinations thereof, wherein the LLM is configured to (i) receive, as input, construction project data associated with an ongoing construction project, (ii) receive, as input, a context-based prompt, and (iii) based on an evaluation of the context-based prompt in view of, at least, the first training data set and the construction project data, output a contextual response to the context-based prompt,
receive a request to generate a construction activity summary for the ongoing construction project, the construction activity summary associated with a given timeframe of the ongoing construction project, the request including the context-based prompt,
generate the construction activity summary by inputting the request into the LLM, the construction activity summary including the contextual response,
cause a client device to present a first interface to a user, the first interface usable for one or more of viewing the construction activity summary, editing the construction activity summary, or combinations thereof,
receive input associated with the construction activity summary, via the first interface, and
retrain the LLM by carrying out a second machine learning process on a second training data set that includes (i) the first training data set and (ii) one or more of the context-based prompt, the construction project data, the evaluation, the contextual response, the construction activity summary, the given timeframe, the request, the input, or combinations thereof.

2. The computing platform of claim 1, further comprising program instructions stored on the at least one non-transitory computer-readable medium that are executable by the at least one processor such that the computing platform is configured to cause the client device to present a user suggestion to the user via a second user interface, and
wherein the LLM is further configured to receive, as input, the construction activity summary and, based on an evaluation of the construction activity summary in view of, at least, the first and second training data sets, output the user suggestion.

3. The computing platform of claim 1, further comprising program instructions stored on the at least one non-transitory computer-readable medium that are executable by the at least one processor such that the computing platform is configured to determine at least one suggested action, and
wherein the LLM is further configured to receive, as input, the construction activity summary and, based on an evaluation of the construction activity summary in view of, at least, the first and second training data sets, output the at least one suggested action.

4. The computing platform of claim 3, further comprising program instructions stored on the at least one non-transitory computer-readable medium that are executable by the at least one processor such that the computing platform is configured to execute one or more application program interfaces (APIs) to execute the suggested action.

5. The computing platform of claim 3, further comprising program instructions stored on the at least one non-transitory computer-readable medium that are executable by the at least one processor such that the computing platform is configured to
cause the client device to present the at least one suggested action to the user via a second user interface;
receive user input, via the client device, associated with the at least one suggested action;
modify the at least one suggested action to generate a modified suggested action; and
execute one or more APIs to execute the modified suggested action.

6. The computing platform of claim 1, wherein the input associated with the construction activity summary includes one or more of an approval of the construction activity summary, a rejection of the construction activity summary, an edit to the construction activity summary, or combinations thereof.

7. The computing platform of claim 1, wherein receiving the request to generate the construction activity summary includes receiving the context-based prompt from the user via the client device.

8. The computing platform of claim 1, wherein receiving the request to generate the construction activity summary includes receiving the context-based prompt from an API of the computing platform.

9. The computing platform of claim 1, wherein the construction activity summary includes one or more of construction project quality information, construction project financial information, construction project schedule information, construction project safety information, construction project scope information, or combinations thereof.

10. The computing platform of claim 1, wherein the construction activity summary includes a plurality of construction data objects and a ranking of importance for each of the construction data objects, the construction activity summary having the plurality of data objects ordered based on the ranking of importance, and
wherein the LLM is further configured to receive, as input, the construction activity summary and, based on an evaluation of the construction activity summary in view of, at least, the first and second training data sets, output the ranking of importance.

11. The computing platform of claim 1, wherein the construction activity summary includes at least one user alert, the at least one user alert associated with a future timeframe, the future timeframe to occur at a time later than the given timeframe, and
wherein the LLM is further configured to receive, as input, the construction activity summary and, based on an evaluation of the construction activity summary in view of, at least, the first and second training data sets, output one or more of the at least one user alert, the future timeframe, or combinations thereof.

12. At least one non-transitory computer-readable medium, wherein the at least one non-transitory computer-readable medium is provisioned with program instructions that, when executed by at least one processor, cause a computing platform to:
train a large language model (LLM) by carrying out a first machine learning process on a first training data set that includes first construction-based data associated with one or more of a user, a plurality of reference construction projects, a construction-based application of the computing platform, or combinations thereof, wherein the LLM is configured to (i) receive, as input, construction project data associated with an ongoing construction project, (ii) receive, as input, a context-based prompt, and (iii) based on an evaluation of the context-based prompt in view of, at least, the first training data set and the construction project data, output a contextual response to the context-based prompt;
receive a request to generate a construction activity summary for the ongoing construction project, the construction activity summary associated with a given timeframe of the ongoing construction project, the request including the context-based prompt;
generate the construction activity summary by inputting the request into the LLM, the construction activity summary including the contextual response;
cause a client device to present a first interface to a user, the first interface usable for one or more of viewing the construction activity summary, editing the construction activity summary, or combinations thereof;
receive input associated with the construction activity summary, via the first interface; and
retrain the LLM by carrying out a second machine learning process on a second training data set that includes (i) the first training data set and (ii) one or more of the context-based prompt, the construction project data, the evaluation, the contextual response, the construction activity summary, the given timeframe, the request, the input, or combinations thereof.

13. The at least one non-transitory computer-readable medium of claim 12, wherein the at least one non-transitory computer-readable medium is also provisioned with program instructions that, when executed by at least one processor, cause the computing platform to determine at least one suggested action, and
wherein the LLM is further configured to receive, as input, the construction activity summary and, based on an evaluation of the construction activity summary in view of, at least, the first and second training data sets, output the at least one suggested action.

14. The at least one non-transitory computer-readable medium of claim 13, wherein the at least one non-transitory computer-readable medium is also provisioned with program instructions that, when executed by at least one processor, cause the computing platform to execute one or more application program interfaces (APIs) to execute the suggested action.

15. The at least one non-transitory computer-readable medium of claim 13, wherein the at least one non-transitory computer-readable medium is also provisioned with program instructions that, when executed by at least one processor, cause the computing platform to:
cause the client device to present the at least one suggested action to the user via a second user interface;
receive user input, via the client device, associated with the at least one suggested action;
modify the at least one suggested action to generate a modified suggested action; and
execute one or more APIs to execute the modified suggested action.

16. The at least one non-transitory computer-readable medium of claim 12, wherein the input associated with the construction activity summary includes one or more of an approval of the construction activity summary, a rejection of the construction activity summary, an edit to the construction activity summary, or combinations thereof.

17. A method carried out by a computing platform, the method comprising:
training a large language model (LLM) by carrying out a first machine learning process on a first training data set that includes first construction-based data associated with one or more of a user, a plurality of reference construction projects, a construction-based application of the computing platform, or combinations thereof, wherein the LLM is configured to (i) receive, as input, construction project data associated with an ongoing construction project, (ii) receive, as input, a context-based prompt, and (iii) based on an evaluation of the context-based prompt in view of, at least, the first training data set and the construction project data, output a contextual response to the context-based prompt;
receiving a request to generate a construction activity summary for the ongoing construction project, the construction activity summary associated with a given timeframe of the ongoing construction project, the request including the context-based prompt;
generating the construction activity summary by inputting the request into the LLM, the construction activity summary including the contextual response;
causing a client device to present a first interface to a user, the first interface usable for one or more of viewing the construction activity summary, editing the construction activity summary, or combinations thereof;
receiving input associated with the construction activity summary, via the first interface; and
retraining the LLM by carrying out a second machine learning process on a second training data set that includes (i) the first training data set and (ii) one or more of the context-based prompt, the construction project data, the evaluation, the contextual response, the construction activity summary, the given timeframe, the request, the input, or combinations thereof.

18. The method of claim 17, further comprising determining at least one suggested action, and
wherein the LLM is further configured to receive, as input, the construction activity summary and, based on an evaluation of the construction activity summary in view of, at least, the first and second training data sets, output the at least one suggested action.

19. The method of claim 18, further comprising executing one or more application program interfaces (APIs) to execute the at least one suggested action.

20. The method of claim 18, further comprising causing the client device to present the at least one suggested action to the user via a second user interface;
receiving user input, via the client device, associated with the at least suggested action;
modifying the at least one suggested action to generate a modified suggested action; and
executing one or more APIs to execute the modified suggested action.
